(19) United States
(12) Patent Application Publication
(10) Pub. No.: US 2003/0048263 A1
(43) Pub. Date: Mar. 13, 2003

(54) Mosaic filter multi-spectral imaging

(76) Inventor: Rolf Holger Wolters, Honolulu, HI (US)

Correspondence Address: Martin E. Hsia, P O Box 939, Honolulu, HI, 96808, US

(21) Appl. No.: 09/905,701

(22) Filed: Mar. 19, 2001

(51) Int. Cl. G09G 5/00

(52) U.S. Cl. 345/204

(57) ABSTRACT

Multi-spectral imaging will be done using a solid-state detector array (e.g. a CCD), a mosaic filter mask and simple collection optics.

### INTRODUCTION

A solid-state detector chip, either a CCD or CMOS, merely functions as a photon counter. The process of defining physical parameters that influence which photons are actually counted broadly defines spectroscopy. Imaging can also be done if spatial information is preserved. To accomplish this, an ordered array of pixel-sized filters can mask the CCD or CMOS chip. These filters will define which photons will be detected. With sufficient resolution, this filter mosaic will be binned in a 2×2 or 3×3 (or higher order) matrix, allowing 4 or 9 (or more) optical bands respectively. Essentially, 3-dimensions of information will be derived from a 2-dimensional layout of pixels. The binned pixels provide the 3^{rd} dimension spectral information, while the binned groups define the x and y position.

### On-Chip Spectroscopy

When optical filters of varying known properties are spatially distributed in an ordered fashion, a great deal of information can be gained. This process can very specifically define which photons reach the detector at which exact location. By accounting for the various pixels of the chip and by binning them according to a specific color scheme, specific spectroscopic information can be gathered in a very simplistic manner. This concept is currently in use for color CCD video chips. By increasing the number of color bands recorded, from the 2×2 Cy, G, Ye and Mg to 9 bands, in a 3×3 binning matrix or beyond, precise spectroscopic values can be derived with a reasonable spatial representation. This is graphically represented below.

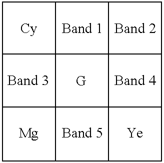

The spectral response for the effective RGB image is achieved through the standard cyan, green, yellow and magenta filter dyes as represented below.

[image]

The remaining bands could have customized spectral signatures, for example peaks that could have their maxima correlate to those of specific compounds. In the following example, Bands 1 to 5 correlate to compounds used to spectroscopically detect cancer and pre-cancer in the cervix.

Band 1: 390 nm±10 nm, Collagen

Band 2: 410 nm±10 nm, Elastin And Oxy-Hemoglobin

Band 3: 545 nm±10 nm, Oxy-Hemoglobin

Band 4: 580 nm±10 nm, Oxy-Hemoglobin

Band 5: 635 nm±10 nm, PP IX (ALA)

[image]

The 3×3 binning represents one spatial “pixel,” an 8×10 array of which is shown below. Spatially, this chip has 80 “pixels”, while the actual chip would have 720 pixels when using a 3×3 binning mode. Modern CCD chips have as many as several Megs of pixels. Since the actual chip pixel size is on the order of 5 μm or below, reasonable spatial resolution will still be retained. With the appropriate filter mosaic, the spatial resolution would still equal that of a several 100,000 pixel gray-scale chip with “pixel” sizes of 15 μm or less.

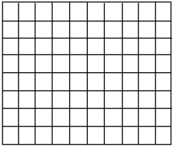

The photons that pass through the filter mosaic will be of a very specific wavelength. The unfortunate aspect of this technique is the loss of signal. 1/9^{th} of the photons would reach the detector to do spectroscopy, if their energy matches the spectroscopic bands being looked at. Using high QE CCD chips and minimizing collection optics, the best system QE would still be under 5%.

### Filter Mosaic Technology

This technology is dependent on the ability to manufacture a filter mosaic in the appropriate size dimension to effectively overlay and match the pixels of the chip, which is on the order of 5 μm. The general dye techniques used for RGB filters produce bands too broad to allow for highly resolved spectroscopy (see spectra above), while still appropriate for the spotting camera function of the chip. The filter resolution will come from uniformly dispersed discretely sized nanometer polystyrene spheres that will produce narrow optical windows through which only photons of very specific energies can travel. The concept utilizes the particle nature of light in that a specific wavelength and certain harmonics can physically pass through an ordered array of particles, as is shown in the diagram. Other wavelengths are physically blocked and higher harmonics can be blocked by a bandpass filter.

[image]

In the diagram, if the desired transmission wavelength is 400 nm, for example, the particle diameter, d, plus the inter-particle length, l, must equal half the desired wavelength, 200 nm. Adjusting d and the optically clear surfactant lengths l/2, will determine the band width of the optical filter. A larger l will produce a wider band.

By utilizing current lithographic microchip manufacturing processes, effective masking can be achieved to allow for filter construction.

### Polystyrene Nanoparticles

Uniform polystyrene spheres can be synthesized from its molecular precursors by creating a single mass nucleation event in a solution, and then terminating growth by temperature or surfactant manipulation at a later defined time. The particles can retain their solubility through organic functionalization. This would then allow for their solubility in a resist for transport to the filter construction. The functionalization chain length would also define the inter-particle distance, thereby influencing the resolution of the passable optical band. Once the resist has been deposited in its appropriate location, subsequent drying would cause a dense close packed array of the spheres, again with the spacing determined by the surfactant molecules used for functionalization.

In the claims:

1. (New). A device, comprising:
a plurality of binned pixels, each of said binned pixels comprising an array of single pixels;
a plurality of mosaics of filters, each mosaic of filters masking at least a portion of a corresponding binned pixel, and each of said filters in each of said mosaics masking a single pixel;
wherein each of said filters transmits light of at least one selected frequency band to a corresponding single pixel;
wherein at least one of such filters in each of said mosaics has a spectral resolution of approximately at most 20 nanometers centered around at least one desired transmission wavelength;
wherein said desired transmission wavelengths are selected to coincide with peaks in spectral signatures whose maxima correlate to those of specific compounds;
whereby said binned pixels provide spatial resolution in an image; and
whereby said mosaics of filters and said binned pixels provide spectral resolution in an image.

2. (New). A device according to claim 1, wherein said filters constitute uniformly spaced, equally sized nanometer spheres, wherein adjacent nanometer spheres are spaced apart from each other by a uniform distance of approximately half of said desired transmission wavelength.

3. (New). A device according to claim 1, wherein said single pixels are approximately 5 micrometers.

4. (New). A device according to claim 1, wherein each of said binned pixels consists of an array of 3×3 single pixels.

5. (New). A device according to claim 1, wherein each of said mosaics of filters contains a filter transmitting 390 nm, with a resolution of at most approximately 20 nanometers.

6. (New). A device according to claim 1, wherein each of said mosaics of filters contains a filter transmitting 410 nm, with a resolution of at most approximately 20 nanometers.

7. (New). A device according to claim 1, wherein each of said mosaics of filters contains a filter transmitting 545 nm, with a resolution of at most approximately 20 nanometers.

8. (New). A device according to claim 1, wherein each of said mosaics of filters contains a filter transmitting 580 nm, with a resolution of at most approximately 20 nanometers.

9. (New). A device according to claim 1, wherein each of said mosaics of filters contains a filter transmitting 635 nm, with a resolution of at most approximately 20 nanometers.

10. (New). A device, comprising:
a plurality of binned pixels, each of said binned pixels comprising a 3×3 array of single pixels;
a plurality of mosaics of filters, each mosaic masking a corresponding binned pixel, and each of said filters masking a single pixel;
wherein each of said filters transmits light of at least one selected frequency band to a corresponding single pixel;
wherein said selected frequency band for one of such filters in each of said mosaics is 390 nanometers, plus or minus approximately 10 nanometers;
wherein said selected frequency band for one of such filters in each of said mosaics is 410 nanometers, plus or minus approximately 10 nanometers;
wherein said selected frequency band for one of such filters in each of said mosaics is 545 nanometers, plus or minus approximately 10 nanometers;
wherein said selected frequency band for one of such filters in each of said mosaics is 580 nanometers, plus or minus approximately 10 nanometers;
wherein said selected frequency band for one of such filters in each of said mosaics is 635 nanometers, plus or minus approximately 10 nanometers;
whereby said binned pixels provide spatial resolution in an image; and
whereby said mosaics of filters and said binned pixels provide spectral resolution in an image.

11. (New). A process for using a solid state detector chip having a plurality of single pixels, comprising:
binning said single pixels to define a plurality of binned pixels, each of said binned pixels consisting of an array of single pixels;
filtering light transmitted to at least a single pixel in each of said binned pixels, whereby filtered light of a desired transmission wavelength, plus or minus approximately 10 nanometers, is transmitted to said single pixel in each of said binned pixels;
wherein said desired transmission wavelength is selected to coincide with a peak in a spectral signature of a specific compound;
combining said binned pixels to provide spatial resolution in an image; and
detecting said specific compound in said image from said filtered light.
